(19) United States
(12) Patent Application Publication
(10) Pub. No.: US 2011/0246499 A1
(43) Pub. Date: Oct. 6, 2011

(54) METHOD AND SYSTEM FOR EVALUATING COMPLIANCE WITHIN A CONFIGURATION-MANAGEMENT SYSTEM

(76) Inventors: Yuval Carmel, Tel Aviv (IL); Ido Ish-Hurwitz, Kfar-Saba (IL)

(21) Appl. No.: 12/750,234

(22) Filed: Mar. 30, 2010

(51) Int. Cl. G06F 17/30

(52) U.S. Cl. 707/769; 707/E17.014

(57) ABSTRACT

One embodiment of the present invention is directed to a compliance evaluation and validation system. The compliance evaluation and validation system comprises compliance rules, stored in computer readable medium, including one or more mass-storage devices and electronic memories, and a compliance-rule execution engine that parses compliance rules and generates, from information extracted from compliance rules, a first query executed by a query-execution engine to select configuration items from a configuration-management database and final query executed by a query-execution engine to select configuration items from a set of configuration items retrieved from the configuration-management database.

### TECHNICAL FIELD

The present invention is related to configuration management and, in particular, to configuration-management subsystems for evaluating and validating compliance of a system with respect to various configuration-management criteria.

### BACKGROUND

While electronic computers, networked computers, and distributed computer systems provide enormously useful and capable computational and communications resources, management and maintenance of computers and administration of computer systems often involve significant cost; time, and personnel overheads. Even the very first, primitive computer systems were associated with significant management and administrative overheads. As electronic computing evolved, many routine management and administrative tasks have been automated and incorporated into operating systems and management applications. However, at the same time, the complexities of individual computers, computer systems, and communications interconnections between computers and computer systems, have also increased, so that despite continued efforts to further automate operations and management, the overhead expended for computer-system administration and management continues to represent a significant overhead for organizations which employ computer systems.

Highly functional and useful computer-system-management tools have been developed in order to assist system administrators and information-technology (“IT”) personnel in carrying out a variety of management tasks, including configuration-management-database systems that store computational models of computer systems, automated discovery-and-dependency-mapping (“DDM”) processes that analyze and monitor computer systems in order to populate configuration-Management databases (“CMDBs”) with various types of stored data entities, and many additional tools and applications based on CMDBs. The computational models of complex computer systems stored in CMDBs facilitate analysis and monitoring of computer-system operations. System administrators and IT personnel can visually inspect graphical renderings of components, subcomponents, and relationships between components and subcomponents of complex systems, monitor system health, model proposed changes to complex computer systems, and carry out many other, similar tasks. System administrators, IT personnel, and other users of CMDBs and configuration-management tools and applications based on CMDBs continue to seek new tools, functionality, and features to further enhance the ability of system administrators and IT personnel to manage complex computer systems.

### BRIEF DESCRIPTION OF THE DRAWINGS

FIG. 1 illustrates a portion of a complex distributed computing environment.

FIG. 2 illustrates a hierarchical-component view of the portion of the computing environment shown in FIG. 1.

FIG. 3 illustrates representation of a networked computer system by configuration items and relationships stored in a configuration-management database.

FIG. 4 illustrates configuration items and relationship entities that are stored in configuration-management database systems.

FIG. 5 illustrates a structured compliance rule that represents one embodiment of the present invention.

FIGS. 6A-C illustrate automated evaluation of a compliance rule, such as the compliance rule discussed with reference to FIG. 5, according to one embodiment of the present invention.

FIGS. 7A-B provide control-flow diagrams for a configuration-management system that includes a compliance-rule execution subsystem and compliance-rule management subsystem for executing and managing compliance rules, such as the structured compliance rule shown in FIG. 5, according to one embodiment of the present invention.

FIG. 8 illustrates a typical electronic computer that executes TQL execution engines, CMDB systems, and compliance-evaluation-and-validation rules and subsystems that represent embodiments of the present invention.

FIGS. 9A-B illustrate a portion of the compliance-rule-administration subsystem of a configuration-management system that represents one embodiment of the present invention.

FIGS. 10A-B show interfaces displayed by various additional configuration-management-system tools and applications, which obtain compliance information by executing compliance rules, according to one embodiment of the present invention.

FIG. 11 provides four examples of compliance rules defined, stored, and automatically executed within a configuration-management system by a compliance-evaluation-and-validation system that represents one embodiment of the present invention.

### DETAILED DESCRIPTION

One embodiment of the present invention is directed to providing for automated evaluation and validation of compliance of a computing system or computational environment with various compliance rules. A compliance evaluation and validation subsystem is provided, by one embodiment of the present invention, within a set of tools and applications based on a configuration-management database. The compliance evaluation and validation subsystem provides interfaces for creation and management of structured compliance rules as well as for execution of compliance rules to determine the compliance status of components and subcomponents within a computer system or computational environment with respect to the compliance rules.

Configuration-management databases and configuration-management systems may be implemented in many different ways, and various compliance-evaluation-and-validation subsystems that represent embodiments of the present invention may be implemented to integrate with these various different types of configuration-management systems and configuration-management-database systems. Currently, many configuration-management systems provide for creation of detailed computational models that describe the components, subcomponents, and interrelationships between components and subcomponents of complex computer systems, including complex systems of networked computers and distributed computer systems. However, to date, configuration-management systems have lacked convenient and effective tools for evaluating compliance of the components and subcomponents within complex computer systems with various rules and constraints based on the attributes and interrelationships of the components and subcomponents.

As one example of evaluating compliance within a computer system, a system administrator or IT analyst may decide that all individual workstations running a particular financial package must be connected to at least one financial database management system running on a remote mainframe-class computer system. System administrators and IT personnel, having established the rule, may additionally wish to manually evaluate a complex computer system for compliance with this rule, and other such rules, or, often more preferably, arrange for compliance to be monitored automatically, at regular intervals, and whenever the configuration of the complex computer system is altered in a way in which compliance of the system with the rules may be affected. Currently, manual evaluation of even a single rule may well involve a lengthy and tedious interaction with a configuration-management database (“CMDB”), involving multiple queries and iterations, and with a large potential for errors and oversights. Alternatively, specialized applications or scripts with embedded CMDB queries may be developed, on an ad hoc basis, to monitor configuration of complex computer systems for compliance with one or a few particular rules and constraints. However, a general compliance-evaluation-and-validation tool, within the suite of available applications and tools provided by configuration-management systems, has not been available.

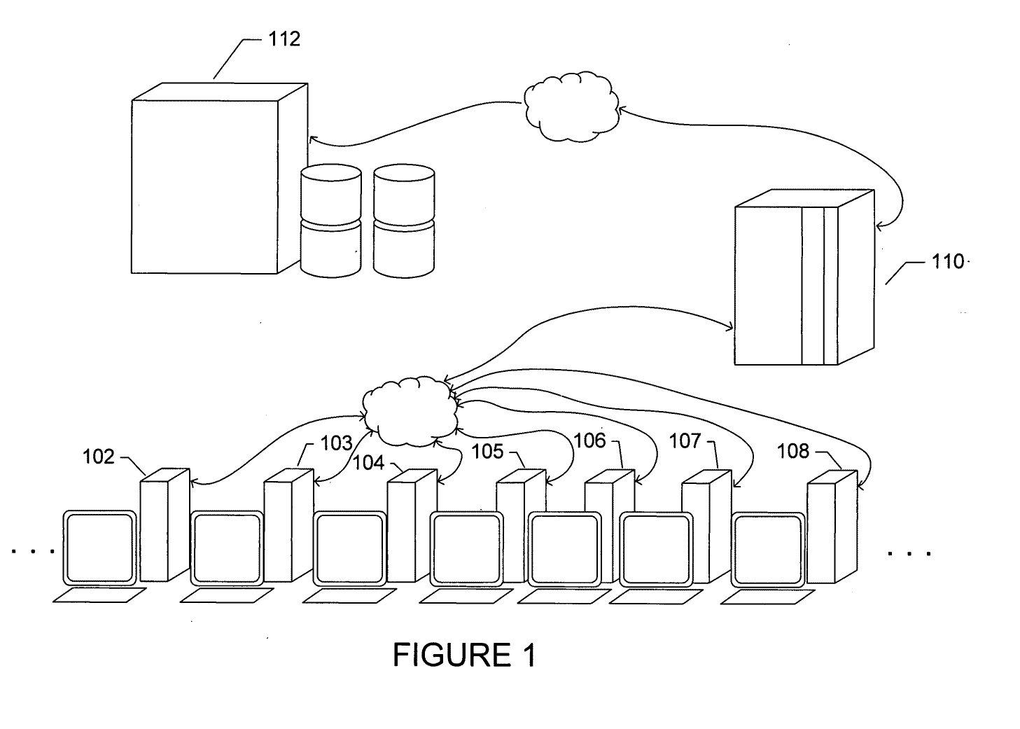

FIG. 1 illustrates a portion of a complex distributed computing environment. In FIG. 1, a large number of personal computers or workstations 102-108 are networked with one another and with a larger computer system 110, in turn connected, by a different communications network, to a large data-storage system 112. Real-world computing environments may involve thousands, tens of thousands, or more interconnected computer systems of various capacities and complexities, multiple communications networks, and a large number of additional components, from backup-power-generation facilities to geographically dispersed redundant data-storage facilities. The small, exemplary portion of a computing environment, shown in FIG. 1, is provided merely for illustration, not as, in any way, exemplifying the complexity of the structure of real-world systems.

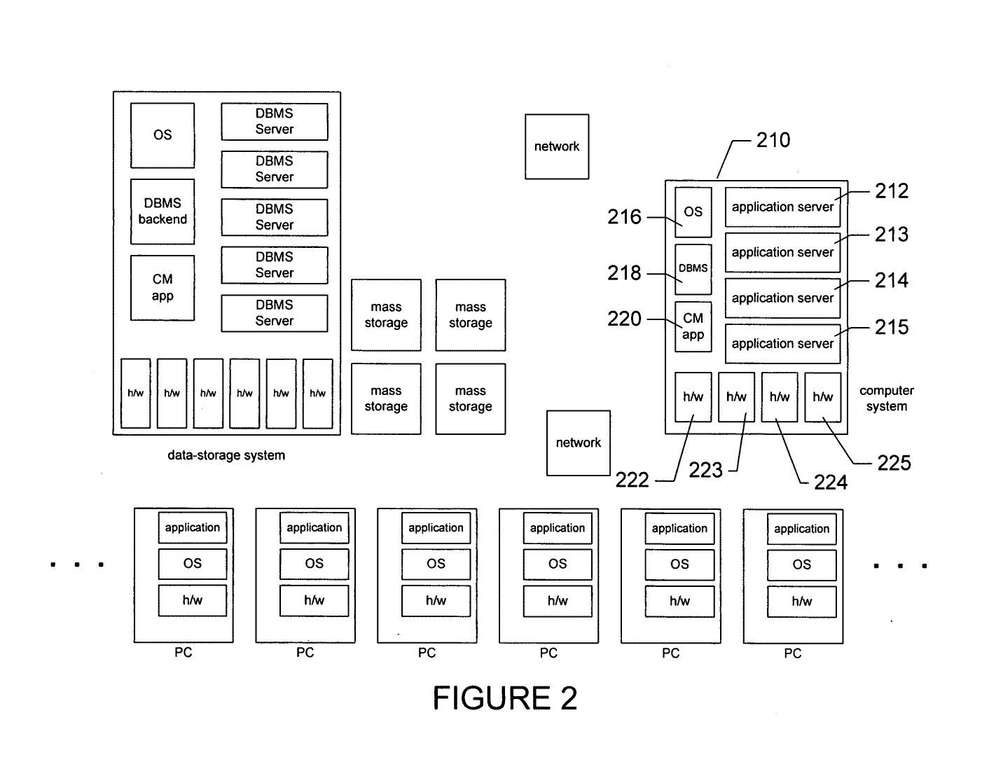

The portion of the complex computing environment, shown in FIG. 1, can be more abstractly viewed as a hierarchical collection of components. FIG. 2 illustrates a hierarchical-component view of the portion of the computing environment shown in FIG. 1. In FIG. 2, each individual computer system, such as computer system 110 in FIG. 1, is viewed as a hierarchical collection 210 of components. For example, the large computer system (110 in FIG. 1) may be viewed as containing a number of application servers 212-215, an operating system 216, database management system 218, and a local configuration-management application 220, as well as various hardware components 222-225. Of course, for an even moderately sized computer system, there may be many hundreds, thousands, or more internal components, with various internal components themselves containing additional hierarchical levels of subcomponents.

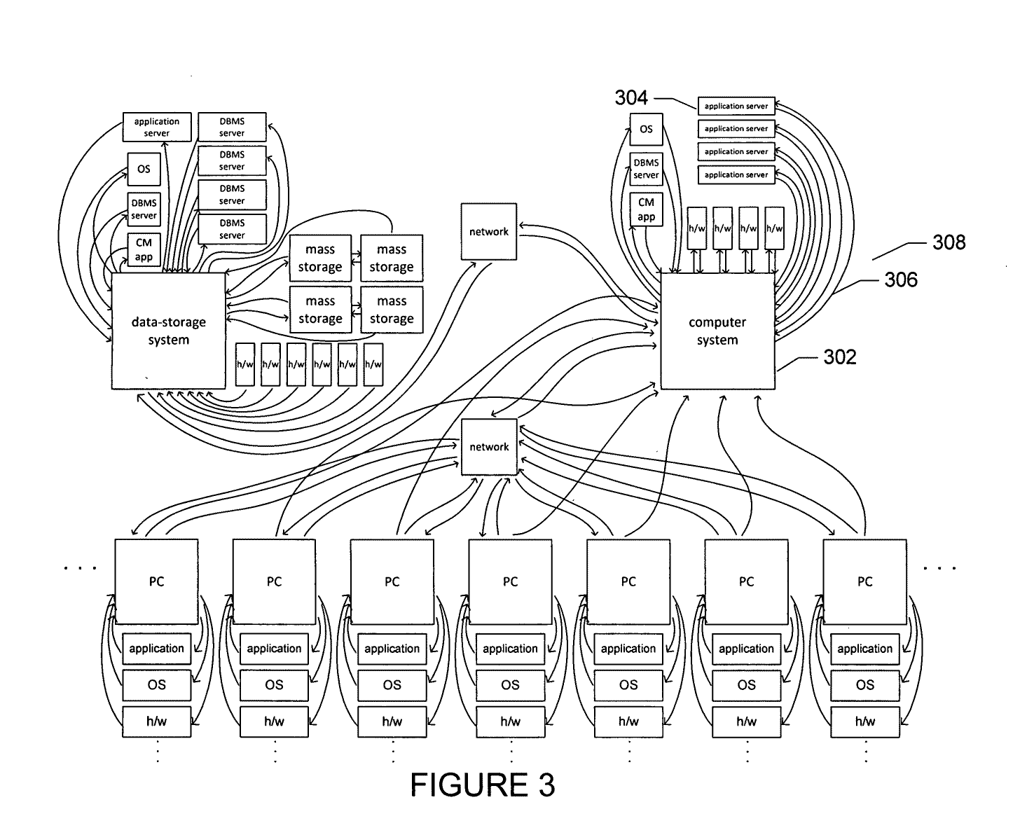

FIG. 3 illustrates representation of a networked computer system by configuration items and relationships stored in a configuration-management database. In FIG. 3, various components of the different computer systems, shown in FIGS. 1 and 2, are abstracted as configuration-item (“CI”) nodes, represented by CI data entities, referred to as “CIs,” stored in any of various different types of configuration-management database systems (“CMDBs”) in various different types of data structures, files, and other data-containing resources managed by CMSDs. For example, computer 110 in FIG. 1, shown as computer 210 in FIG. 2, is, in the CMDB, represented by a CI 302 of type “mainframe computer.” Components contained within the computer (210 in FIG. 2), such as application-service program 212, are also represented by CIs, such as CI 304. Various relationships between the CIs are represented by relationship entities stored in the CMDB. For example, the fact that application-service program 304 is contained within, or executed by, computer system 302 may be represented by a “contains” relationship, shown as curved arrow 306, and/or, alternatively, by a “contained in” relationship, represented by curved arrow 308. There may be many different relationships between a given pair of CIs in a CMDB, representing various dependencies, constraints, hierarchical relationships and orderings, and other characteristics of the computer system represented by the CIs and relationships stored in a CMDB. Relationship entities may represent hierarchical relationships, and a path of relationship entities may represent a relationship between multiple CIs.

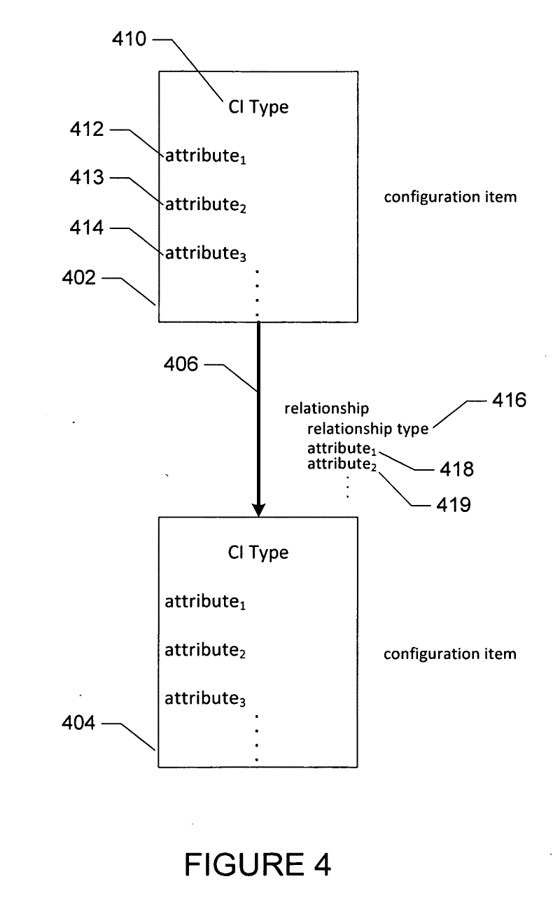

FIG. 4 illustrates configuration items and relationship entities that are stored in configuration-management database systems. In FIG. 4, two CIs 402 and 404 are related by a relationship entity 406. Each CI, such as CI 402, is represented by a stored data structure or by data distributed across one or more underlying data structures, within the CMDB. Stored data that represents a CI generally includes the CI type 410 and one or more additional attributes 412-414 that describe the CI. Attributes may include a name, version, indication of a manufacturer or distributor, times associated with configuration events related to the CI, such as last update, next maintenance check, and many other such attributes. Attributes can be encoded in familiar numeric and character-based data types, or in unstructured data types, such as those provided by relational database management systems. Relationships are also stored within, or distributed across, data structures, and, like CIs, include a relationship type 416 and one or more additional attributes 418-419.

A CMDB can be created manually, through various CMDB administration and query interfaces, may be created by an automated discovery-and-dependency-mapping (“DDM”) process, or by a combination of manual and automated techniques. A computational model of a computing environment, stored in a CMDB, can provide a basis for automated monitoring, evaluation, analysis, and reporting of events, operational characteristics, and other aspects of the computing environment. For example, the CIs and relationships represented in a CMDB may specify, with respect to workstations 102-108 shown in FIG. 1, that a workstation-configuration-analysis program should be run locally, on the work stations, at a particular time each day in order to provide for detection of various configuration-related situations that may require automated or manual attention from IT personnel and/or system administrators. For example, a greater-than-desired degree of disk fragmentation, substantial memory leaks from a memory allocation system, a workstation resource unavailable due to failure of a resource-allocation subsystem, and other such problems may be detected and addressed. As another example, attributes within the CIs representing the workstations within the CMDB may include specifications of times for automated backups of mass-storage devices within, or associated with, the workstations. Certain automated management and maintenance functions may be carried out directly by the CMDB system, while others may be detected by monitoring and maintenance applications that access the CMDB through various CMDB interfaces.

In general, a large computational system may be associated with implicit or explicit rules and constraints. For example, with respect to the portion of the computing environment shown in FIG. 1, there may be an implicit or explicit rule that all workstations executing a particular application program must be connected to a server computer running a counterpart application-service program, and that the particular application program on each workstation must additionally be logged in to the corresponding application-service program. As another example, there may be a rule that workstations running versions of an application program greater than, or equal to, some threshold version number need to be connected to a remote application service provided by a first vendor, while workstations running versions of an application program less than the threshold version number must be connected to a application-service programs provided by a second vendor.

Currently, CMDBs do not provide tools for evaluating compliance of components of a computer system with arbitrary rules and constraints, such as those discussed in the preceding paragraph. Although the CMDB can be accessed, through various interfaces, by system administrators and IT personnel to manually ascertain whether various components of a computer system currently comply with one or a few rules or constraints, the process may be extremely time-consuming, tedious, and error prone. Manual validation of computer systems for compliance with sets of rules and constraints is generally not feasible. Alternatively, automated scripts or programs can be developed to access the CMDB in order to monitor compliance with various rules and constraints. In general, such programs are developed specifically for particular programmatically-expressed rules and constraints, and therefore difficult to expand or enhance in order to, for example, monitor and evaluate compliance with newly developed rules and constraints. Furthermore, developing, testing, debugging, and verifying operation of application programs developed specifically for monitoring and validating compliance with respect to various rules and constraints represents a significant expense in time, cost, and personnel.

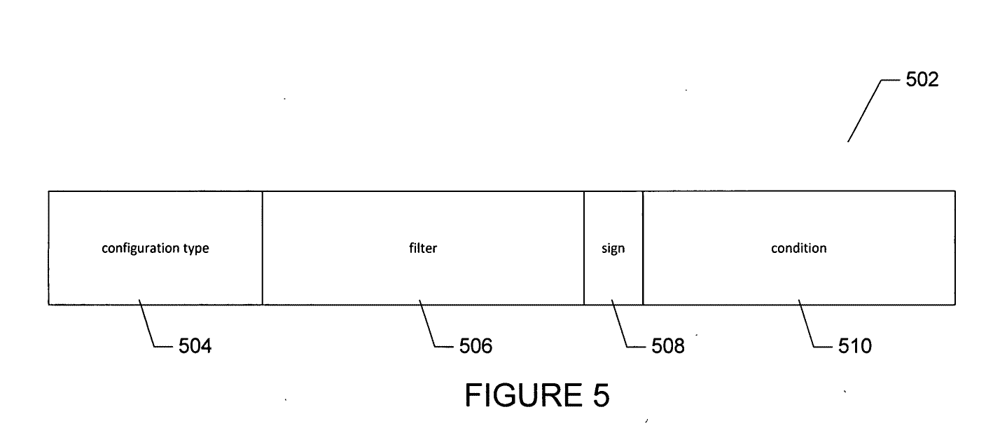

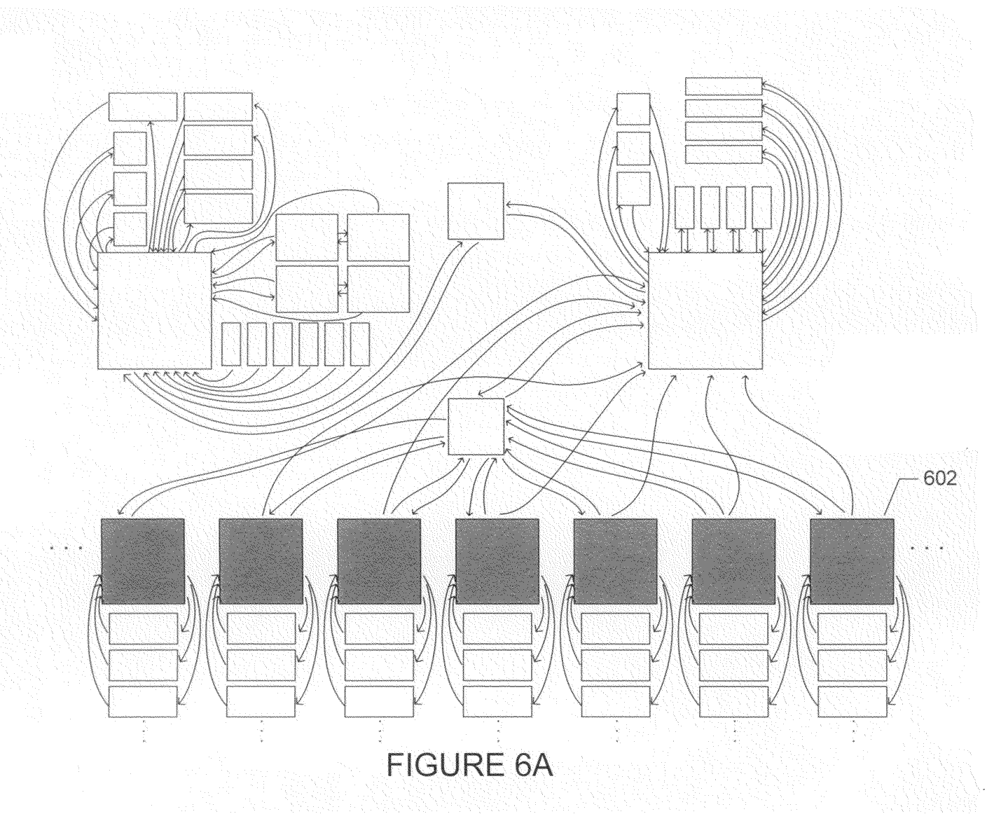

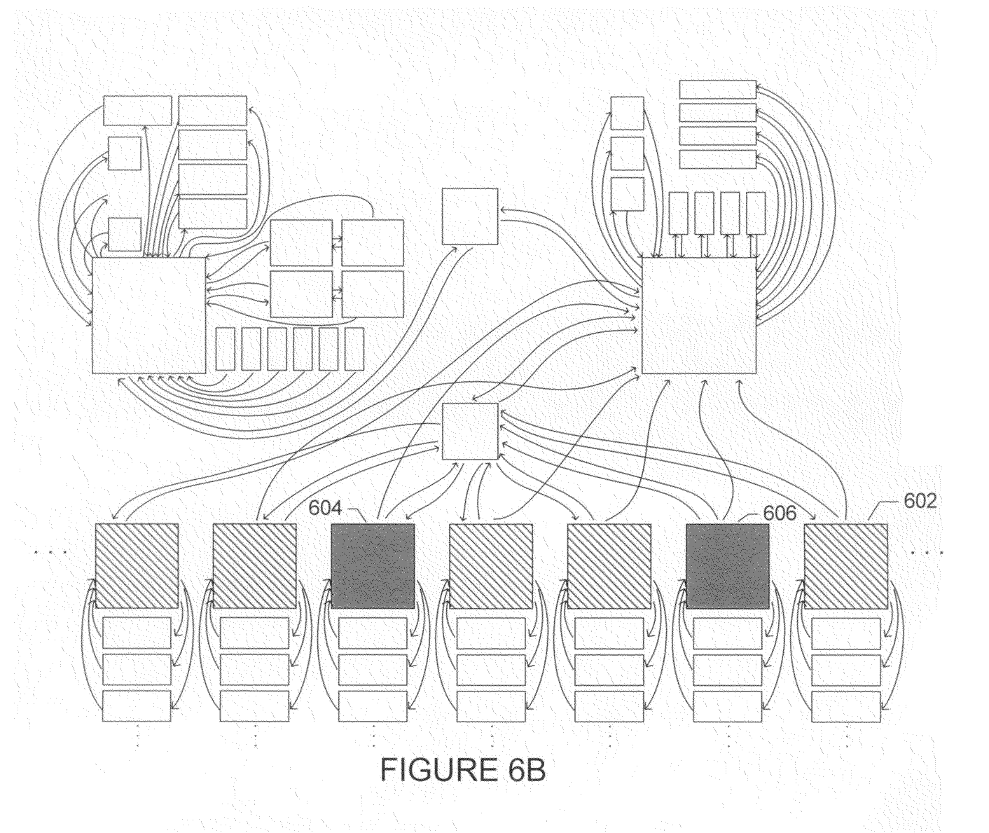

For these reasons, various embodiments of the present invention provide a tool for automated evaluation and validation of computational systems and environments for compliance with various rules and constraints associated with management of the computational systems and environments. Expression and encoding of these rules and constraints is generalized, according to certain embodiments of the present invention, to development of structured compliance rules. FIG. 5 illustrates a structured compliance rule that represents one embodiment of the present invention. The structured compliance rule 502 includes a configuration-item type (“CI type”) 504, a filter 506, a sign 508, and a condition 510. These portions of the compliance rule are encoded in a computer-readable format so that they can be extracted and used to construct CMDB queries that can, in turn, be executed with respect to a CMDB by a query-execution engine implemented above a CMDB. In certain embodiments of the present invention, both the filter 506 and condition 510 are expressed as topological queries (“TQs”) executed by a topological-query-language (“TQL”) execution engine implemented above a CMDB.

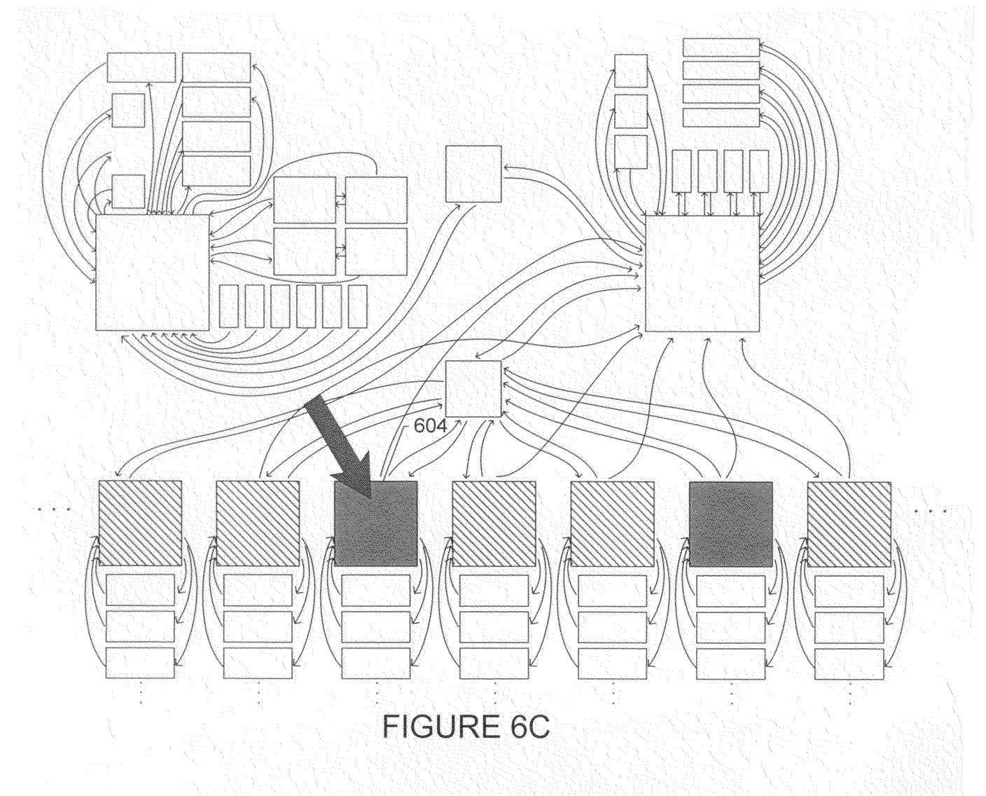

FIGS. 6A-C illustrate automated evaluation of a compliance rule, such as the compliance rule discussed with reference to FIG. 5, according to one embodiment of the present invention. Compliance-rule execution may be carried out by a compliance-rule execution engine within, or associated with, a configuration-management system and/or CDMB. FIGS. 6A-C use the representation of the computing environment, stored as CIs and relationships in a CMDB, discussed above with reference to FIG. 3. In a first step, the configuration type (504 in FIG. 5) and filter (506 in FIG. 5) portions of the compliance rule 502 are combined to form a TQ that, when executed by a TQL execution engine, returns a set of CIs with the configuration type specified by the configuration-type portion (504 in FIG. 5) of the compliance rule and with attributes and associated relations such that a TQ expression corresponding to the filter portion (506 in FIG. 5) of the compliance rule is satisfied with respect to each of the returned CIs. In certain embodiments, a filter expression is expressed as a Boolean expression and is satisfied by a CI when the filter expression evaluates to TRUE following substitution of CI attributes for variables in the Boolean expression. In one example, shown in FIG. 6A, the configuration-type portion (504 in FIG. 5) of the compliance rule specifics a workstation CI type. In FIG. 6A, the CIs corresponding to workstations are shaded, such as CI 602. As shown in FIG. 6B, the filter portion (506 in FIG. 5) of the compliance rule specifies those workstations that execute a particular application program. In FIG. 6B, the workstations that execute the particular application program 604 and 606 are shown darkly shaded, with the remaining workstations, such as workstation 602, shown in crosshatch. The configuration-type and filter portions of the compliance rule may be assembled together in a single TQ or, alternatively, the filter portion may be assembled into a TQ that is executed on the result set of an initial TQ corresponding to the configuration-type portion of the compliance rule. Finally, as shown in FIG. 6C, the condition portion (510 in FIG. 5) of the compliance rule is extracted and used to construct a TQ that is executed on the result set produced by the filter TQ or configuration-type/filter TQ. For example, the condition may be that selected workstations are connected, through a network, to a server computer that executes a service-application program corresponding to the particular application program for which the workstations were selected by the filter TQ. In FIG. 6C, only workstation 604 is selected by the condition TQ.

The sign portion (508 in FIG. 5) of the compliance rule determines whether those CIs for which the condition evaluates to TRUE value are selected by the TQ or whether those CIs which the condition evaluates to FALSE value are selected by the TQ. For example, were the condition to specify that a workstation is not connected to a server running the corresponding service-application program, and the sign is positive, then execution of the condition TQ returns those workstations not connected to a server running the corresponding application-service program, which may constitute the non-compliant workstations for a particular computing system or environment. Were the condition to specify that a workstation is connected to a server running the corresponding application-service program, and the sign is negative, then execution of the condition TQ returns those workstations which are not connected to the server executing the corresponding application-service program, again perhaps representing non-compliant workstations for a given system or environment. The sign portion provides convenient flexibility in expressing compliance rules. Often, it is far easier to express a particular condition as a positive condition, with a positive sign portion, than as a negative condition or, in other cases, it is far easier to express a particular condition as a negative condition than as a positive condition.

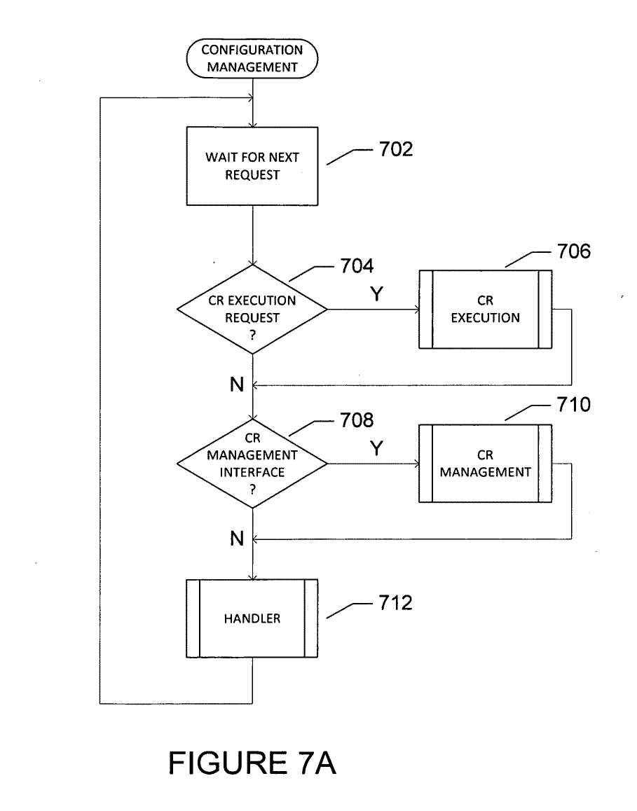

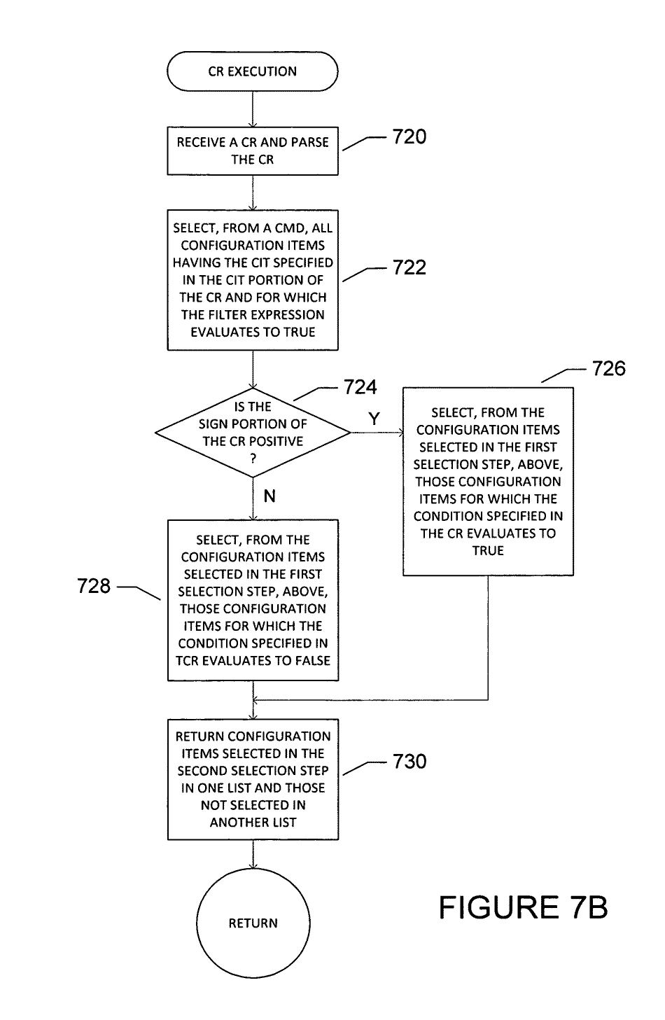

FIGS. 7A-B provide control-flow diagrams for a configuration-management system that includes a compliance-rule execution subsystem and compliance-rule management subsystem for executing and managing compliance rules, such as the structured compliance rule shown in FIG. 5, according to one embodiment of the present invention. FIG. 7A shows a portion of an event-handling loop within a configuration-management system. In step 702, the configuration-management system waits for a next request or event to handle. When the next occurring event is a compliance-rule-execution request, as determined in step 704, then a compliance-rule-execution routine is called, in step 706. When a request has been received for provision of a compliance-rule management interface, as determined in step 708, then a compliance-rule-management-interface-providing subsystem routine is called in step 710. All other events and requests are handled by a general request-and-event handler 712.

FIG. 7B provides a control-flow diagram for the compliance-rule-execution routine called in step 706 of FIG. 7A. In step 720, the compliance-rule-execution routine receives a compliance rule for execution, and parses the compliance rule in order to extract the configuration-type, filter, sign, and condition portions of the compliance rule, discussed above with reference to FIG. 5. In step 722, the configuration-item type and the filter expression, parsed from the received compliance rule, are assembled as a TQ and submitted to a TQL execution engine, which returns a set of configuration items of the specified configuration type for which the filter expression is satisfied. Then, in step 724, the compliance-rule-execution routine determines whether or not the sign portion of the compliance vile is positive. When the sign is positive, the compliance-rule-execution routine, in step 726, selects, from the configuration items returned in step 722, those configuration items for which the condition portion of the received compliance rule evaluates to TRUE by executing a TQ query with respect to the configuration items returned by the initial TQ query, in step 722. When the sign portion is negative, then the second TQ query, executed in step 728, selects, from the configuration items returned in step 722, those configuration items for which the condition portion of the received compliance rule evaluates to FALSE. Alternatively, the condition and filter portions may be expressed in queries where the expressions are satisfied, for particular configuration items, in ways other than evaluating to a Boolean value. In step 730, those configuration items selected by the first TQ and by the second TQ, executed in either step 726 or 728, are returned to the requester of the compliance-rule execution in a first list, and those configurations items selected by the first TQ and not selected by the second TQ are returned to the requester in second list. In general, the CIs in the first list are compliant and the CIs in the second list are non-compliant.

Creating and storing compliance rules using the compliance-evaluation-and-validation subsystem that represents one embodiment of the present invention, addresses deficiencies of both manual validation methods and ad hoc validation methods, discussed above. Structured compliance rules, such as the structured compliance rule discussed with reference to FIG. 5, allow for straightforward expression of any of many different types of rules and constraints devised by system administrators and IT personnel for a computer system, and are easily stored and managed within a compliance-rule database or as a subsystem of a CMDB. The rules can be executed, by use of a TQL execution engine, to provide accurate and timely identification of those CIs within a computer system that comply, or fail to comply, with any of various compliance rules devised for management of the computer system. Time consuming, expensive, and error-prone ad hoc script or application development is no longer needed.

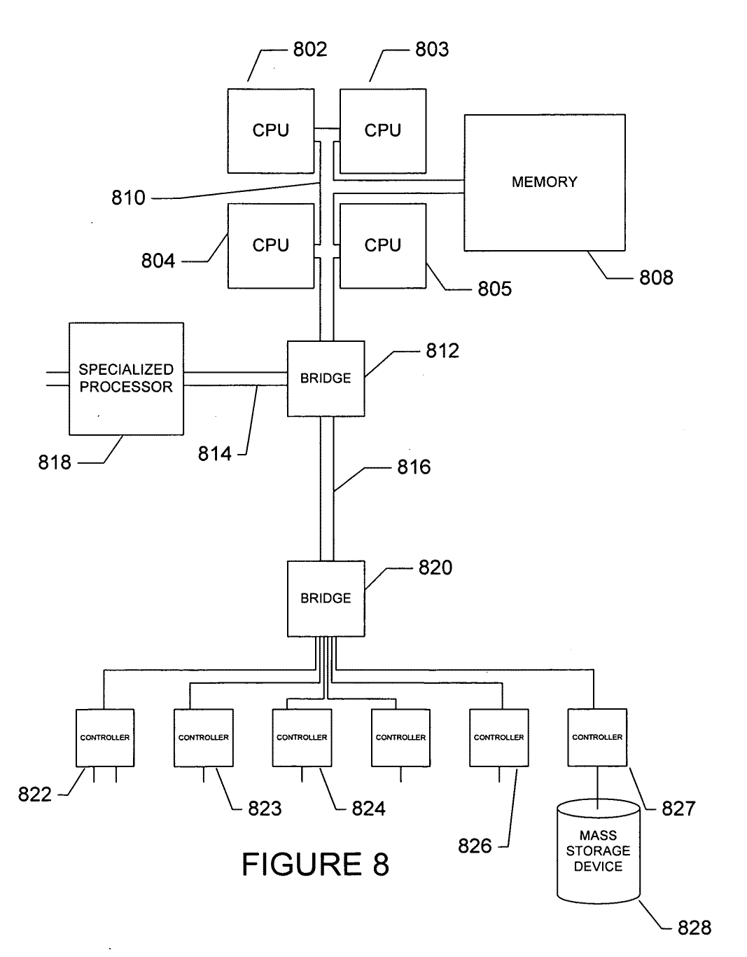

FIG. 8 illustrates a typical electronic computer that executes TQL execution engines, CMDB systems, and compliance-evaluation-and-validation rules and subsystems that represent embodiments of the present invention. The computer system contains one or multiple central processing units (“CPUs”) 802-805, one or more electronic memories 808 interconnected with the CPUs by a CPU/memory-subsystem bus 810 or multiple busses, a first bridge 812 that interconnects the CPU/memory-subsystem bus 810 with additional busses 814 and 816, or other types of high-speed interconnection media, including multiple, high-speed serial interconnects. These busses or serial interconnections, in turn, connect the CPUs and memory with specialized processors, such as a graphics processor 818, and with one or more additional bridges 820, which are interconnected with high-speed serial links or with multiple controllers 822-827, such as controller 827, that provide access to various different types of mass-storage devices 828, electronic displays, input devices, and other such components, subcomponents, and computational resources. Compliance rules are generally stored in memory and in various types of computer-readable medium, including magnetic-disk platters and optical storage devices.

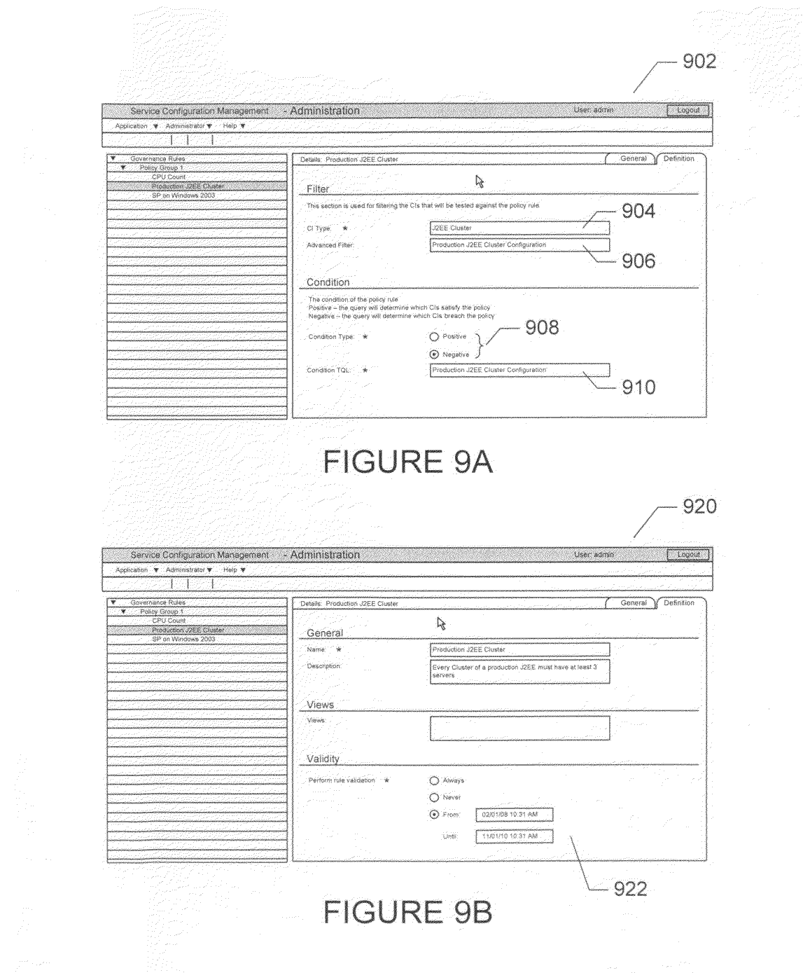

FIGS. 9A-B illustrate a portion of the compliance-rule-administration subsystem of a configuration-management system that represents one embodiment of the present invention. The compliance-rule-administration subsystem provides an interface for defining new compliance rules 902, shown in FIG. 9A. Text-entry windows allow for specification of the configuration-item type 904, filter 906, sign 908, and condition 910 portions of a structured compliance rule, according to one embodiment of the present invention. A second interface 920, illustrated in FIG. 9B, allows a system administrator or IT personnel to specify, for a particular compliance rule, various modes of automated execution for validation of a computer system 922. Additional administration tools allow compliance rules to be edited, deleted, retrieved, aggregated into hierarchical groupings, and other such administrative functionalities.

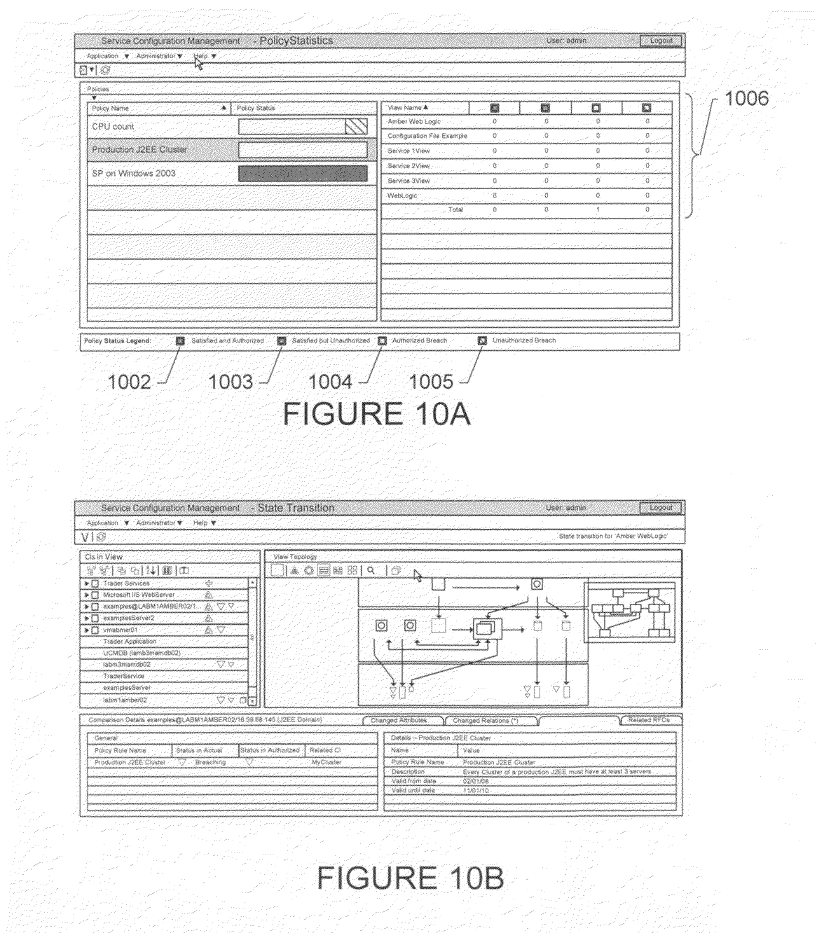

FIGS. 10A-B show interfaces displayed by various additional configuration-management-system tools and applications, which obtain compliance information by executing compliance rules, according to one embodiment of the present invention. In FIG. 10A, a policy-statistics window, displayed on an electronic display, is shown. The policy-statistics window displays the compliance status 1002-1005 of various configuration items 1006, with the compliance status obtained by executing compliance rules. Similarly, FIG. 10B shows a state-transition interface which provides graphical indications of configuration items that transition to non-compliant status.

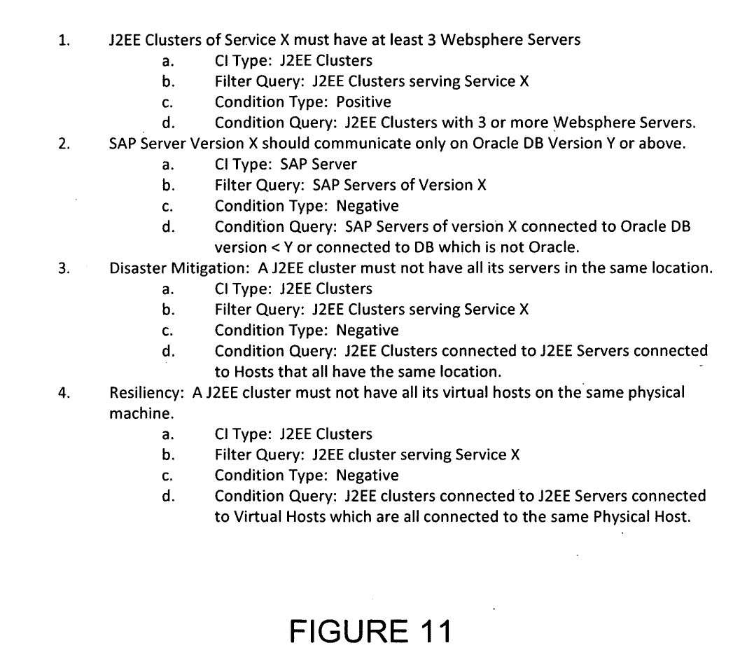

FIG. 11 provides four examples of compliance rules defined, stored, and automatically executed within a configuration-management system by a compliance-evaluation-and-validation system that represents one embodiment of the present invention. For each of the compliance rules, an English-language statement of the compliance rule is followed by a breakdown of the corresponding structured compliance rule by portions, as discussed above with reference to FIG. 5.

Although the present invention has been described in terms of particular embodiments, it is not intended that the invention be limited to these embodiments. Modifications will be apparent to those skilled in the art. For example, compliance-evaluation-and-validation subsystems and compliance-rule-execution routines and subsystems may be implemented in a variety of different ways by varying any of the common implementation and development parameters, including modular organization, programming language, data structures, control structures, underlying CMDB, operation system foundation, and other such parameters. Described embodiments of the present invention employ a TQL execution engine for executing TQs against a computational representation of a computer system stored in the CMDB. The TQL execution engine and CMDB may, in turn, be based on a relational database system and relational query language, such as the structured query language (“SQL”). In such implementations, configuration items, including configuration type and other attributes, may be stored in one or more relational tables. Relationship entities may also be stored in one or more relational tables, and associations of configuration items with relationships may be additionally stored in one or more relational tables. Compliance rules can be generally defined according to the capabilities and features of the underlying TQL execution engine and TQL, as well as according to the types of attributes associated with configuration items and relationship entities in an underlying CMDB.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A compliance evaluation and validation system, executed on one or more computer systems, comprising:
compliance rules, stored in computer readable medium, including one or more mass-storage devices and electronic memories; and
a compliance-rule execution engine that parses the compliance rules and generates, from information extracted from the compliance rules, a first query executed by a query-execution engine to select configuration items from a configuration-management database and a final query executed by a query-execution engine to select configuration items from a set of configuration items retrieved from the configuration-management database.

2. The compliance evaluation and validation system of claim 1 wherein each compliance rule includes:
specification of a configuration-item type;
a filter expression;
a sign; and
a condition expression.

3. The compliance evaluation and validation system of claim 2 wherein the compliance-rule execution engine generates, from a compliance rule, a first query to select configuration items from a configuration-management database by embodying the specification of the configuration-item type extracted from the compliance rule in the first query that the compliance-rule execution engine then submits to the query-execution engine to select configuration items from the configuration-management database having the configuration-item type.

4. The compliance evaluation and validation system of claim 3 wherein the compliance-rule execution engine generates, from the compliance rule, a second query to select configuration items from the configuration items selected by execution of the first query by embodying the filter expression extracted from the compliance rule in the second query that the compliance-rule execution engine then submits to the query-execution engine to select configuration items from configuration items selected by execution of the first query, the configuration items selected by the second query forming the set of configuration items from which configuration items are selected by the final query.

5. The compliance evaluation and validation system of claim 2 wherein the compliance-rule execution engine generates, from a compliance rule, a first query to select configuration items from a configuration-management database by embodying the specification of the configuration-item type and the filter expression extracted from the compliance rule in the first query that the compliance-rule execution engine then submits to the query-execution engine to select configuration items from the configuration-management database having the configuration-item type and for which the filter expression is satisfied, the configuration items selected by the first query forming the set of configuration items from which configuration items are selected by the final query.

6. The compliance evaluation and validation system of claim 2 wherein the compliance-rule execution engine generates, from a compliance rule, a final query to select configuration items from the set of configuration items for inclusion in a first list of configuration items by embodying the condition expression extracted from the compliance rule in the final query that the compliance-rule execution engine then submits to the query-execution engine to select, when the sign extracted from the compliance rule is positive, configuration items from the set of configuration items for which the condition expression is satisfied and, when the sign extracted from the compliance rule is negative, configuration items from the set of configuration items for which the condition expression is not satisfied, the compliance-rule execution engine including those configuration items of the set of configuration items not included in the first list in a second list of configuration items.

7. The compliance evaluation and validation system of claim 2 wherein the first and final queries are topological queries expressed in a topological-query language and executed by a topological-query-execution engine.

8. The compliance evaluation and validation system of claim 2 wherein the configuration-management database stores configuration items and relationship entities, both configuration items and relationship entities associated with a type attribute and one or more additional attributes.

9. The compliance evaluation and validation system of claim 2 wherein the first and final queries select configuration items by evaluating expressions containing attribute values for configuration items.

10. The compliance evaluation and validation system of claim 9 wherein the first and final queries select configuration items by evaluation of expressions containing attribute values for configuration items.

11. The compliance evaluation and validation system of claim 10 wherein the expressions additionally contain attribute values for relationships, Boolean operators, and relational operators.

12. The compliance evaluation and validation system of claim 1 further including a compliance-rule administration interface that provides for creating, editing, deleting, aggregating, storing, retrieving, and executing compliance rules.

13. The compliance evaluation and validation system of claim 1 further including one or more interfaces to additional configuration-management-system tools and applications through which the additional configuration-management-system tools submit compliance rules for execution and receive configuration-item result sets from execution of compliance rules.

14. A method for executing a compliance rule comprising:
parsing the compliance rule;
generating, from information extracted from the compliance rule, a first query;
executing, by a query-execution engine, the first query to select configuration items from a configuration-management database;
generating, from information extracted from the compliance rule, a final query; and
executing, by a query-execution engine, the final query to select configuration items from a set of configuration items retrieved from the configuration-management database.

15. The method of claim 14 wherein a compliance rule includes:
specification of a configuration-item type;
a filter expression;
a sign; and
a condition expression.

16. The method of claim 15 wherein generating, from information extracted from the compliance rule, the first query further comprises:
embodying the specification of the configuration-item type extracted from the compliance rule in the first query to select configuration items from the configuration-management database having the configuration-item type.

17. The method of claim 16 wherein further comprising:
embodying the filter expression extracted from the compliance rule in a second query to select configuration items from configuration items selected by execution of the first query that satisfy the filter expression, the configuration items selected by the second query forming the set of configuration items from which configuration items are selected by the final query.

18. The method of claim 15 wherein generating, from information extracted from the compliance rule, the first query further comprises:
embodying the specification of the configuration-item type and the filter expression extracted from the compliance rule in the first query to select configuration items from the configuration-management database having the configuration-item type and that satisfy the filter expression, the configuration items selected by the first query forming the set of configuration items from which configuration items are selected by the final query.

19. The method of claim 16 wherein generating, from information extracted from the compliance rule, the final query further comprises:
embodying the condition expression extracted from the compliance rule in the final query that selects configuration items for a first list, when the sign extracted from the compliance rule is positive, configuration items from the set of configuration items for which the condition expression is satisfied and, when the sign extracted from the compliance rule is negative, configuration items from the set of configuration items for which the condition expression is not satisfied, and that includes configuration items in the set of configuration items not included in the first list in a second list

20. A compliance rule, stored in a computer-readable medium, comprising:
specification of a configuration-item type;
a filter expression;
a sign; and
a condition expression.
